(19) United States
(12) Patent Application Publication
(10) Pub. No.: US 2011/0051435 A1
(43) Pub. Date: Mar. 3, 2011

(54) LUMINAIRE MOUNTING APPARATUS AND SYSTEM

(75) Inventors: David R. Pfund, Woodbridge, CT (US); Allison K. Schieffelin, New Haven, CT (US); Joseph Mancinelli, Weston, CT (US); Wooyeon Cho, Stratford, CT (US); Irving Schaffer, Fairfield, CT (US)

(73) Assignee: SYLVAN R. SHEMITZ DESIGNS INCORPORATED, West Haven, CT (US)

(21) Appl. No.: 12/873,349

(22) Filed: Sep. 1, 2010

Related U.S. Application Data
(60) Provisional application No. 61/238,918, filed on Sep. 1, 2009.

(51) Int. Cl. F21V 19/02; F21V 21/00

(52) U.S. Cl. 362/418; 362/382

(57) ABSTRACT

Disclosed is a luminaire mounting apparatus configured for usage with a mounting surface on or in proximity to a work station, the luminaire mounting apparatus including a mounting base configured for association with the mounting surface, at least one support arm associated with and extending from the mounting base, and at least one luminaire and at least one workstation resource being supported by the at least one support arm, wherein the at least one luminaire and the at least one workstation resource are disposed in proximity to the work station.

### FIELD

The disclosure relates generally to a luminaire mounting apparatus, and more particularly to a luminaire mounting apparatus for mounting at least one workstation luminaire.

### BACKGROUND

Monitor stands with adjustable arms are commonly used to support visual display terminals (VDTs) at office workstations and allow for the positioning of the VDTs to accommodate a range of viewing requirements and ergonomic concerns. Where two or more VDTs are deployed in a single workstation, stands with multiple arms are offered eliminating the need for multiple supports that introduce clutter and interfere with office tasks. However, concerns over workstation clutter and appearance are increased by trends in energy efficient office lighting practice that promote the use of local task lights or task/ambient luminaires positioned in proximity to workstation tasks. These luminaires are known to add physical and visual clutter at or on an office workstation, especially when used in concert with monitor stands, and can interfere with office tasks and activities. Moreover, independently deployed VDT and lighting supports often have dissimilar styles and finishes that present an uncoordinated and unattractive workstation aesthetic.

In addition, while office task lights are generally designed to provide the user with a wide range of adjustability and flexibility, they do not anticipate the use of task/ambient luminaires (i.e. luminaires that simultaneously provide both downward task lighting and upward ambient lighting) such that their adjustability is inadequately constrained to prevent glare.

Accordingly, an apparatus that decreases the number of support systems necessary at a workstation would be desirable. It is also desirable that workstation mounted support systems limit the vertical position, tilt and rotation of task/ambient luminaires while providing for broad range rotation of VDTs or other workstation accessories.

### SUMMARY

Disclosed is a luminaire mounting apparatus configured for usage with a mounting surface on or in proximity to a work station, the luminaire mounting apparatus including a mounting base configured for association with the mounting surface, at least one support arm associated with and extending from the mounting base, and at least one luminaire and at least one workstation resource being supported by the at least one support arm, wherein the at least one luminaire and the at least one workstation resource are disposed in proximity to the work station.

Also disclosed is a luminaire mounting system including a mounting surface on or in proximity to a work station, a mounting base mounted to the mounting surface, at least one support arm associated with and extending from the mounting base, and at least one luminaire and at least one workstation resource being supported by the at least one support arm, wherein the at least one luminaire and the at least one workstation resource are disposed in proximity to the work station.

### BRIEF DESCRIPTION OF THE DRAWINGS

The foregoing and other features and advantages of the present invention should be more fully understood from the following detailed description of illustrative embodiments taken in conjuncture with the accompanying Figures in which like elements are numbered alike in the several Figures:

FIG. 1 is a perspective, view of a luminaire mounting apparatus in an exemplary embodiment;

FIG. 2 is a perspective view of the luminaire mounting apparatus of FIG. 1, the apparatus being shown in a mounting apparatus system;

FIG. 3 is a schematic elevation view of the luminaire mounting apparatus of FIG. 1, the apparatus being shown in a mounting apparatus system;

FIG. 4 is a schematic elevation view of the luminaire mounting apparatus of FIG. 1, the apparatus being shown in a mounting apparatus system;

FIG. 5 is a schematic plan view of the luminaire mounting apparatus of FIG. 1, the apparatus being shown in a mounting apparatus system;

FIG. 6 a schematic partial plan view of the luminaire mounting apparatus of FIG. 1;

FIG. 7 is a schematic elevation view of the luminaire mounting apparatus of FIG. 1, the apparatus being shown in a mounting apparatus system;

FIG. 8 is a schematic elevation view of a luminaire mounting apparatus in another exemplary embodiment, the apparatus being shown in a mounting apparatus system;

FIG. 9 is a plan view of a luminaire mounting apparatus in another exemplary embodiment, the apparatus being shown in a mounting apparatus system;

FIG. 10 is a perspective view of the luminaire mounting apparatus of FIG. 9, the apparatus being shown in a mounting apparatus system;

FIG. 11 is another perspective view of the luminaire mounting apparatus of FIG. 9, the apparatus being shown in a mounting apparatus system; and

FIG. 12 is a perspective view of a luminaire mounting apparatus in another exemplary embodiment, the apparatus being shown in a mounting apparatus system.

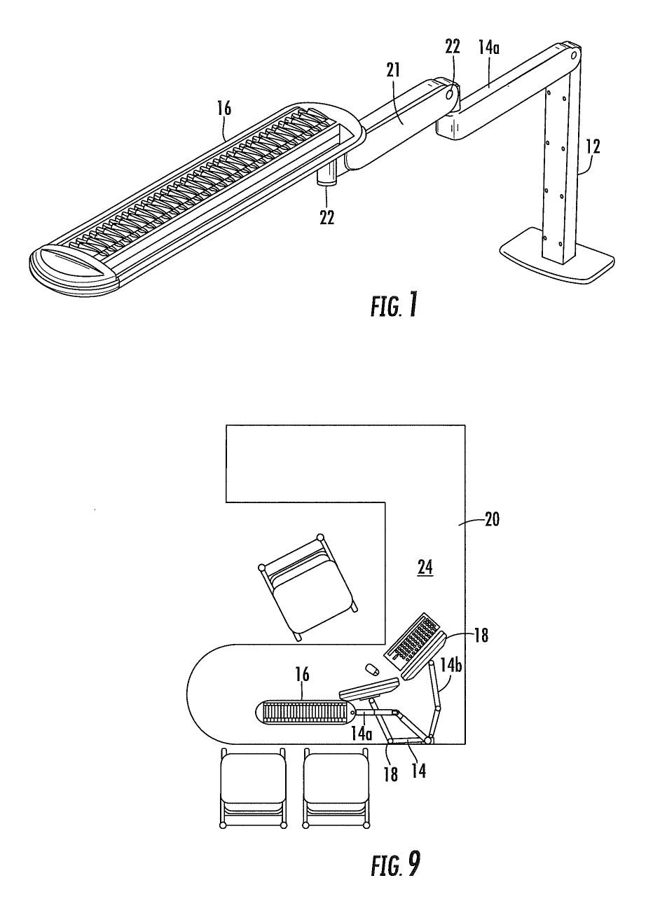

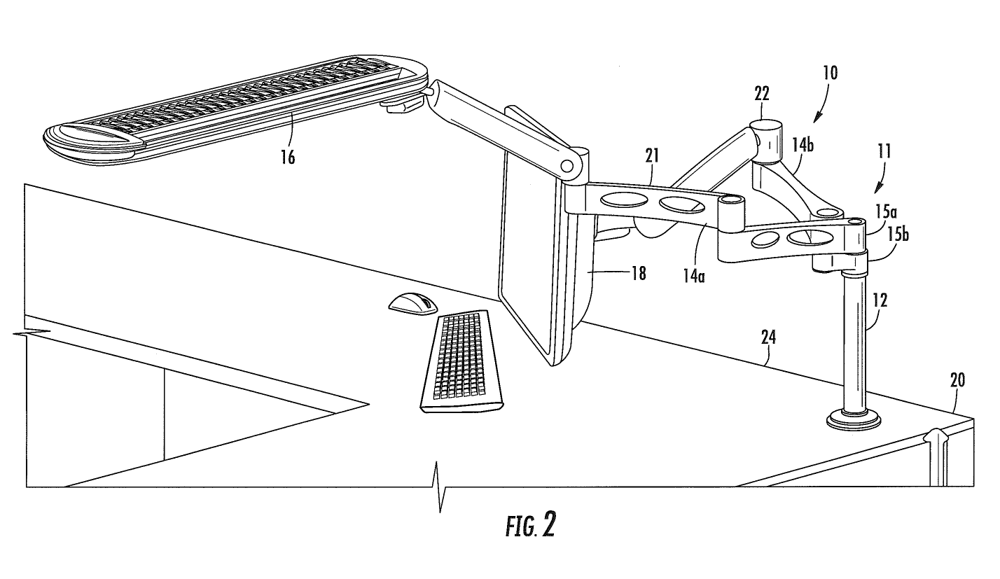

### DETAILED DESCRIPTION

As is shown in Figures, the luminaire mounting apparatus 10 and system 11 includes a mounting base 12, a luminaire support arm 14a associated with the base 12 at association point 15a, and a resource support arm 14b associated with the base 12 at another association point 15b. As shown, the luminaire support arm 14 supports a luminaire 16, and the resource support arm 14b supports a workstation resource 18. The workstation resource 18 may be a VDT(s), document holder(s), and/or any other resource that may be associated with a workstation or desk. Similarly, the luminaire 16 may be a task light, ambient lighting, and/or any other light associated with a workstation 20 or desk, and may incorporate one or more fluorescent lamp(s) and/or LED sources.

As is also shown throughout the Figures, an exemplary embodiment of the apparatus 10 may include luminaire support arms 14a and workstation resource support arms 14b with vertically stepped articulations 21 and swivel/rotation points 22. The articulated segments 21 of the luminaire support arm 14a or the workstation resource support arm 14b may be affixed to each other, the base 12, or the luminaire 16 and resource 18, respectively, via connecting means (screws, apertures, bolts, pegs, etc.) that allow for the various rotations and translational movements shown in the Figures. The connection means that allow for such movement are of course well known in the art.

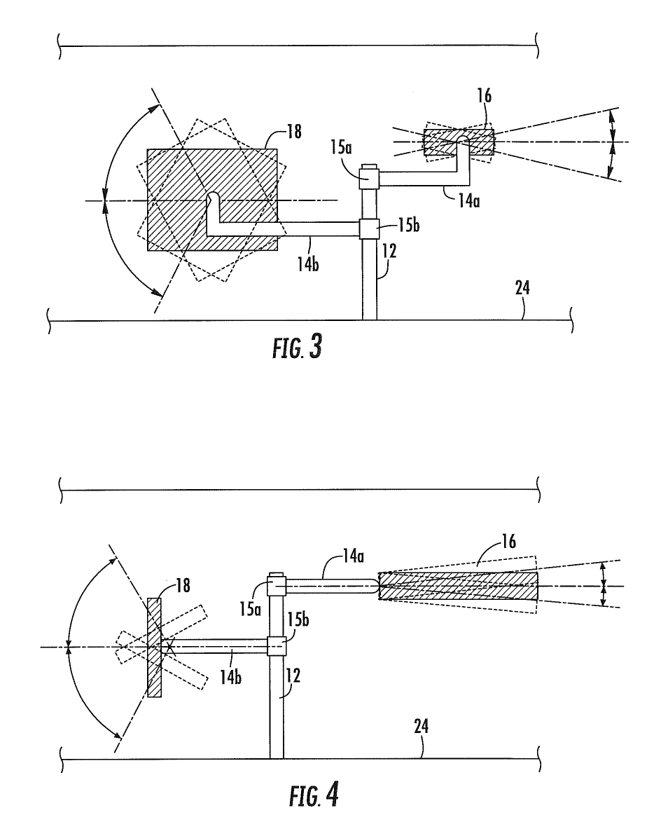

Referring now to the exemplary embodiment of FIGS. 3 and 4, the luminaires 16 are shown to rotate in cross-sectional planes that are perpendicular to a workstation mounting surface 24. This rotation of the luminaires 16 is limited or prevented (at least, as discussed below, in relation to the workstation resource 18) to maintain relationship with lighted worksurface and/or ceiling. On the other hand, rotation of the workstation resources 18 is substantially unlimited. This is very clearly shown in FIGS. 3 and 4, wherein uptilt and downtilt of luminaires 16 is zero or near zero degrees, and the uptilt and downtilt of the workstation resource 18 is substantially more. To the extent that the luminaire is optically designed to provide glare control for seated and standing users when the luminaire is positioned parallel to the mounting surface, limiting the uptilt and downtilt of the luminaire in this manner will advantageously prevent unintentional glare.

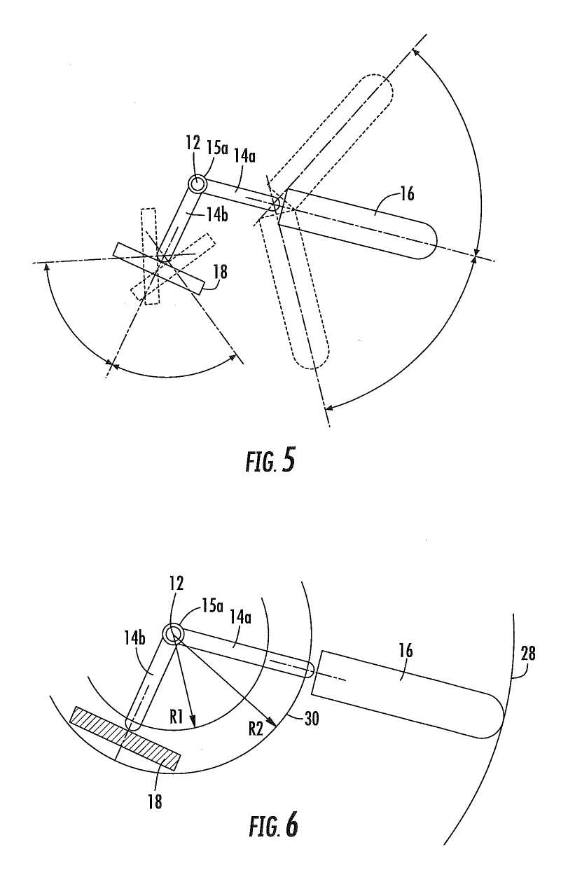

Referring now to the exemplary embodiment of FIG. 5, the luminaire 16 and workstation resource 18 are shown to rotate in cross-sectional plane(s) parallel to the mounting surface 24. In this embodiment, rotation of the luminaire 16 and workstation resource 18 is substantially the same, and limited only by contact with the support arms 14a and 14b respectively or features thereof. Taken together FIGS. 3, 4, and 5 demonstrate the respective rotational limitations and freedoms of the luminaire 16 and workstation resource 18, regardless of any translational movement of the arms 14a and 14b and/or the rotation of the arms/arm segments 14a/21 and 14b/21 relative to the mounting base 12.

Referring now to the exemplary embodiment of FIG. 6, the luminaire support arm 14a and the resource support arm 14b are translationally adjustable towards and away from said mounting base 12 via the articulated segments 21 discussed above. As shown, the luminaire 16 is extendable via the luminaire support arm 14a to a furthest luminaire extent 28 from the mounting base 12 and association point 15a, and the work station resource 18 is extendable via the resource support arm 14b to a furthest resource extent 30 from the mounting base 12 and other association point 15b. As is also shown, the furthest luminaire extent 28 is a greater distance from the mounting base 12 and association points 15 than the furthest resource extent 30. In fact, at least a portion of the luminaire 16 should further away from the base 12 relative to the workstation resources 18 to prevent the workstation resource(s) from interfering with the delivery of light from the luminaire 16 to documents and other workstation tasks located on the mounting surface 24 at a distance from the mounting base 12 and beyond the extent of the workstation resource(s) 18.

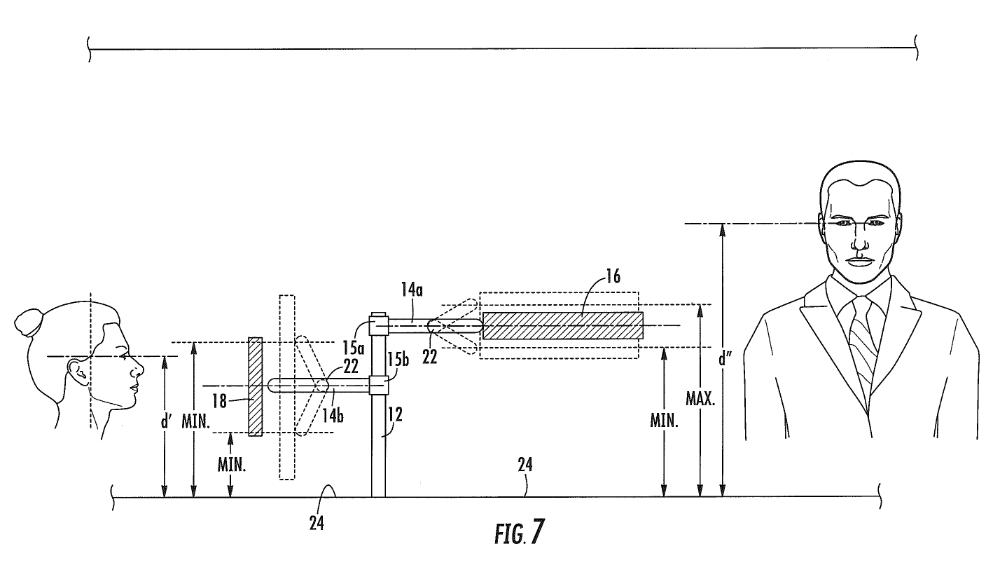

Referring now to the exemplary embodiment of FIG. 7, the luminaire 16 and workstation resource 18 are shown to be translationally adjustable towards and away from the workstation surface 24 via the support arms 14a and 14b, respectively. The ability to adjust the workstation resource 18 in this manner addresses ergonomic relative to the user's posture. The ability to adjust the luminaire 16 in this manner allows the seated user to adjust the task lighting coverage and illuminance on the worksurface 24 and to raise the luminaire to facilitate visual communication with other co-worker(s) seated on the opposite side of worksurface 24, i.e. where the luminaire 16 is positioned between the seated user and the seated co-worker(s). In this exemplary embodiment, the attachment point 15a to arm 14a supporting luminaire 16 is fixed and the translational freedom of luminaire 16 is limited such that the maximum and minimum distance between the luminaire 16 and the workstation surface 28 are predetermined to protect seated and standing users from glare due to the luminaire downlight and uplight, if any, respectively. Attachment point 15b to arm 14b (supporting the workstation resource 18) may or may not be fixed relative to the worksurface 24, wherein the translational freedom of the workstation resource 18 may be substantially uninhibited, thus allowing for greater translational freedom than the luminaire 16.

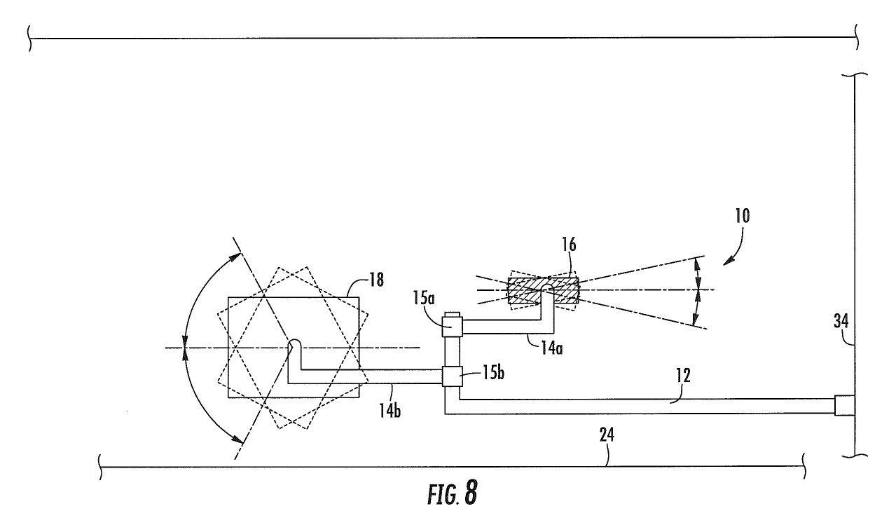

Referring now to the exemplary embodiment of FIG. 8, the luminaire mounting apparatus 10 is shown mounted to a wall 34 in proximity to the workstation 20 and workstation surface 24. In this embodiment, the rotational and translational movements relative to the workstation 20 are maintained. In addition, the luminaire 16 (and furthest extent thereof) remains a greater distance from the association points 15 at the mounting base 12 than does the workstation resource 18 (and furthest extent thereof). Of course, the wall 34 shown in the Figure may be the wall of any office/edifice or a panel within a cubicle or the like.

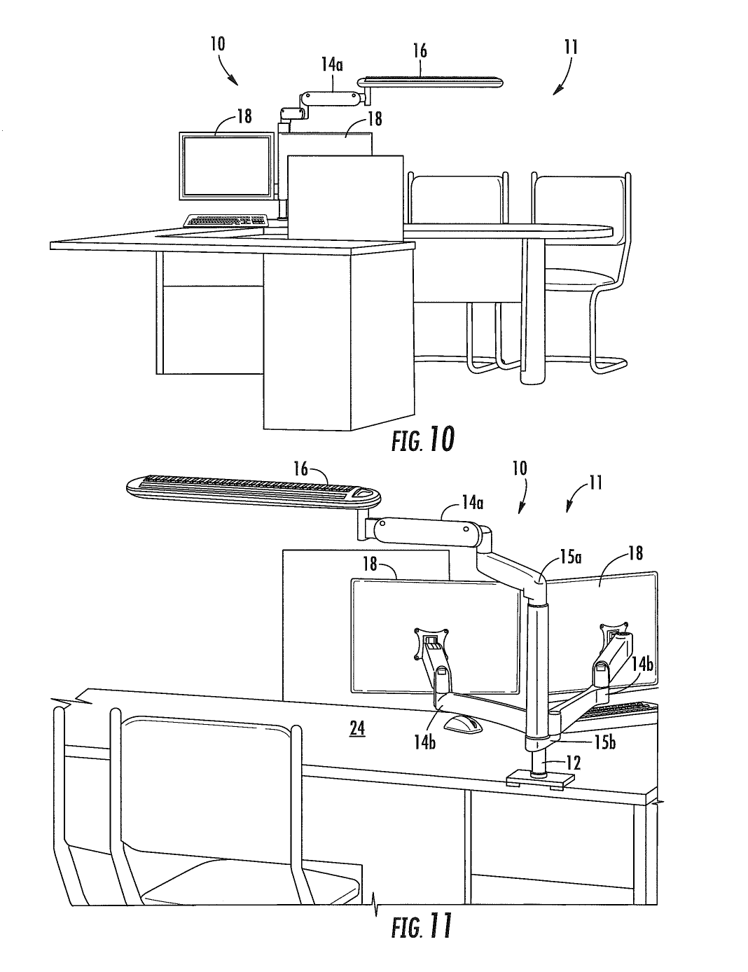

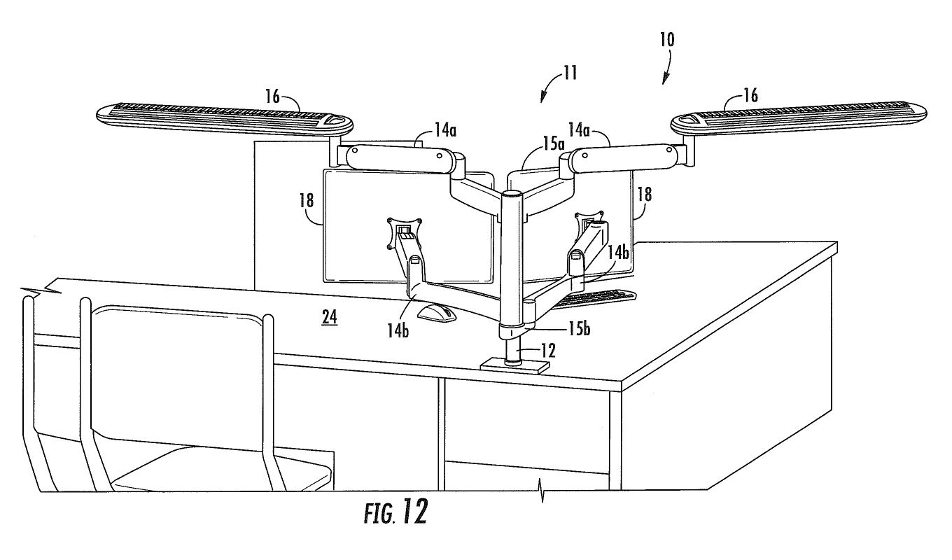

Referring now to FIGS. 9 and 10 the apparatus 10 and system 11 may include any desirable number of support arms 14a and 14b (luminaire or resource) extending from any number of desirable bases 12. These support arms may support any desirable number of luminaires 16 and workstation resources 18.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims. Moreover, unless specifically stated any use of the terms first, second, etc. do not denote any order or importance, but rather the terms first, second, etc. are used to distinguish one element from another.

What is claimed is:

1. A luminaire mounting apparatus configured for usage with a mounting surface on or in proximity to a work station, the luminaire mounting apparatus comprising:
a mounting base configured for association with the mounting surface;
at least one support arm associated with and extending from said mounting base; and
at least one luminaire and at least one workstation resource being supported by said at least one support arm, wherein said at least one luminaire and said at least one workstation resource are disposed in proximity to the work station.

2. The apparatus of claim 1, wherein said at least one support arm is at least one articulated and adjustable luminaire support arm for supporting said luminaire, and at least one articulated and adjustable resource support arm for supporting said workstation resource.

3. The apparatus of claim 1, wherein at least a portion of said at least one luminaire, in at least one luminaire position relative to said at least one workstation resource, is disposed at a greater distance from said mounting base than is said at least one work station resource in at least one work station resource position.

4. The apparatus of claim 2, wherein said at least one luminaire support arm and said at least one resource support arm are translationally adjustable towards and away from said mounting base, said luminaire being extendable via said luminaire support arm to a furthest extent from said mounting base and said work station resource being extendable via said resource support arm to a furthest extent from said mounting base, said furthest extent of said luminaire being a greater distance from said mounting base than said furthest extent of said workstation resource.

5. The apparatus of claim 1, wherein said workstation resource is rotationally mounted to said at least one support arm in at least one plane and said luminaire is mounted to said at least one support arm in a manner that substantially prevents said luminaire from rotating with respect to said at least one support arm in said plane.

6. The apparatus of claim 1, wherein said luminaire and said workstation resource are rotationally mounted to said at least one support arm in at least one plane, said luminaire including a limited freedom of rotation in said at least one plane relative to a comparatively less limited or substantially unlimited freedom of rotation of said work station resource.

7. The apparatus of claim 1, wherein said luminaire and said workstation resource are rotationally mounted to said at least one support arm in all three rotational degrees of freedom, said luminaire including a limited freedom of rotation in cross-sectional planes perpendicular to the workstation surface relative to a comparatively less limited or substantially unlimited freedom of rotation of said work station resource.

8. The apparatus of claim 1, wherein said at least one luminaire and said workstation resource are translationally adjustable towards and away from the workstation via said at least one support arm, said workstation resource including a greater translational freedom than said luminaire.

9. The apparatus of claim 1, wherein said luminaire is at least one of a task light and ambient light, and said workstation resource is at least one of a visual display and a document holder.

10. The apparatus of claim 1, wherein said luminaire is a combination task/ambient light and said workstation resource is at least one of a visual display and a document holder.

11. The apparatus of claim 1, wherein said at least one support arm includes multiple articulated segments.

12. A luminaire mounting system comprising:
a mounting surface on or in proximity to a work station;
a mounting base mounted to said mounting surface;
at least one support arm associated with and extending from said mounting base; and
at least one luminaire and at least one workstation resource being supported by said at least one support arm, wherein said at least one luminaire and said at least one workstation resource are disposed in proximity to said work station.

13. The system of claim 10, wherein said at least one support arm is at least one articulated and adjustable luminaire support arm for supporting said luminaire, and at least one articulated and adjustable resource support arm for supporting said workstation resource.

14. The apparatus of claim 11, wherein at least a portion of said at least one luminaire, in at least one luminaire position relative to said at least one workstation resource, is disposed at a greater distance from said mounting base than is said at least one work station resource in at least one work station resource position.

15. The system of claim 10, wherein said at least one luminaire support arm and said at least one resource support arm are translationally adjustable towards and away from said mounting base, said luminaire being extendable via said luminaire support arm to a furthest extent from said mounting base, and said work station resource being extendable via said resource support arm to a furthest extent from said mounting base, said furthest extent of said luminaire being a greater distance from said mounting base than said furthest extent of said workstation resource.

16. The system of claim 10, wherein said workstation resource is rotationally mounted to said at least one support arm in at least one plane and said luminaire is mounted to said at least one support arm in a manner that substantially prevents said luminaire from rotating with respect to said at least one support arm in said plane.

17. The system of claim 10, wherein said luminaire and said workstation resource are rotationally mounted to said at least one support arm in at least one plane, said luminaire including a limited freedom of rotation in said at least one plane relative to a comparatively less limited or substantially unlimited freedom of rotation of said work station resource.

18. The system of claim 10, wherein said luminaire and said workstation resource are rotationally mounted to said at least one support arm in all three rotational degrees of freedom, said luminaire including a limited freedom of rotation in cross-sectional planes perpendicular to the workstation surface relative to a comparatively less limited or substantially unlimited freedom of rotation of said work station resource.

19. The system of claim 10, wherein said at least one luminaire and said workstation resource are translationally adjustable towards and away from said workstation via said at least one support arm, said workstation resource including a greater translational freedom than said luminaire.

20. The system of claim 10, wherein said luminaire is at least one of a task light and ambient light, and said workstation resource is at least one of a visual display and a document holder.

21. The system of claim 1, wherein said luminaire is a combination task/ambient light and said workstation resource is at least one of a visual display and a document holder.

22. The system of claim 10, wherein said at least one support arm includes multiple articulated segments.

23. The system of claim 10, wherein said mounting surface is at least one of a relatively upward facing surface of said workstation, a wall in proximity to said workstation, and a workstation panel in proximity to said workstation.
